(19) United States
(12) Patent Application Publication
(10) Pub. No.: US 2014/0084230 A1
(43) Pub. Date: Mar. 27, 2014

(54) CONTAINER DATA CENTER AND ADJUSTMENT MEMBER THEREOF

(71) Applicants: CHIH-HUNG CHANG, Tu-Cheng (TW); SHIH-CHIEH CHEN, Tu-Cheng (TW)

(72) Inventors: CHIH-HUNG CHANG, Tu-Cheng (TW); SHIH-CHIEH CHEN, Tu-Cheng (TW)

(21) Appl. No.: 13/649,631

(22) Filed: Oct. 11, 2012

(30) Foreign Application Priority Data
Sep. 21, 2012 (TW) 101134587

(51) Int. Cl. B66F 3/24

(52) U.S. Cl. 254/89 H

(57) ABSTRACT

A container data center includes a container and a number of adjustment members. Each adjustment member includes a base, a jack fixed on the base, and a supporting block fastened between a bottom of the container and the jack. The jack is operated to move the supporting block up and down.

### BACKGROUND

1. Technical Field

The present disclosure relates to a container data center including a plurality of adjustment members.

2. Description of Related Art

A container data center cannot keep level when being placed on an uneven plane. The incline of the container data center may lead to a condition that water in the container data center is hard to discharge from the scuppers, which is troublesome.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a container data center, wherein the container data center includes a plurality of adjustment members.

FIG. 2 is an enlarged view of one of the adjustment members of FIG. 1.

FIG. 3 is an exploded, isometric view of the adjustment member of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

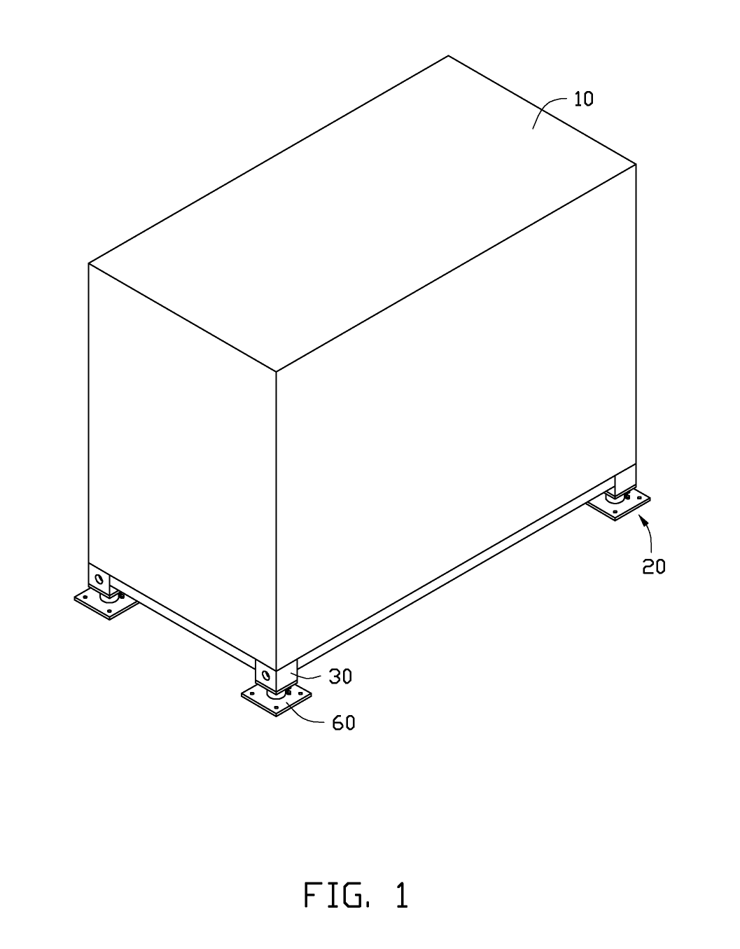

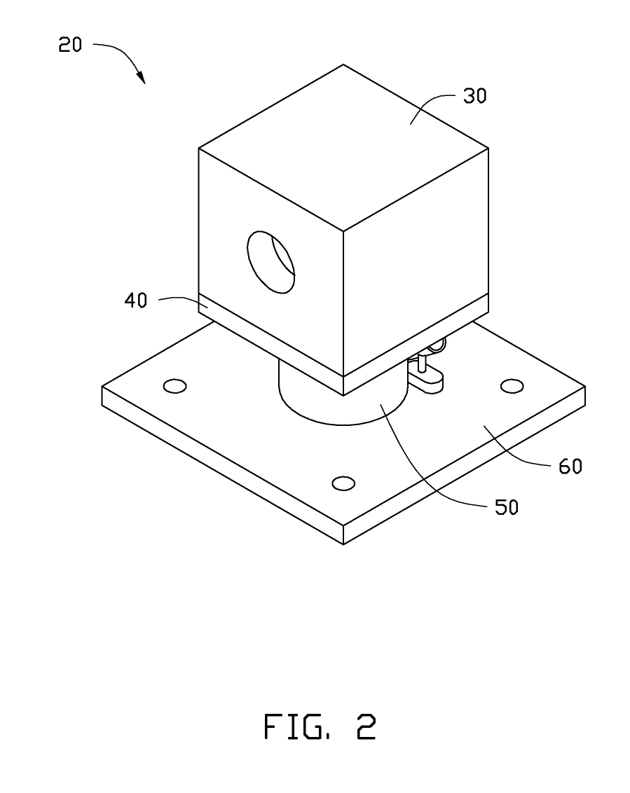

FIGS. 1 and 2 show an exemplary embodiment of a container data center. The container data center includes a container 10 and four adjustment members 20 mounted to a bottom of the container 10.

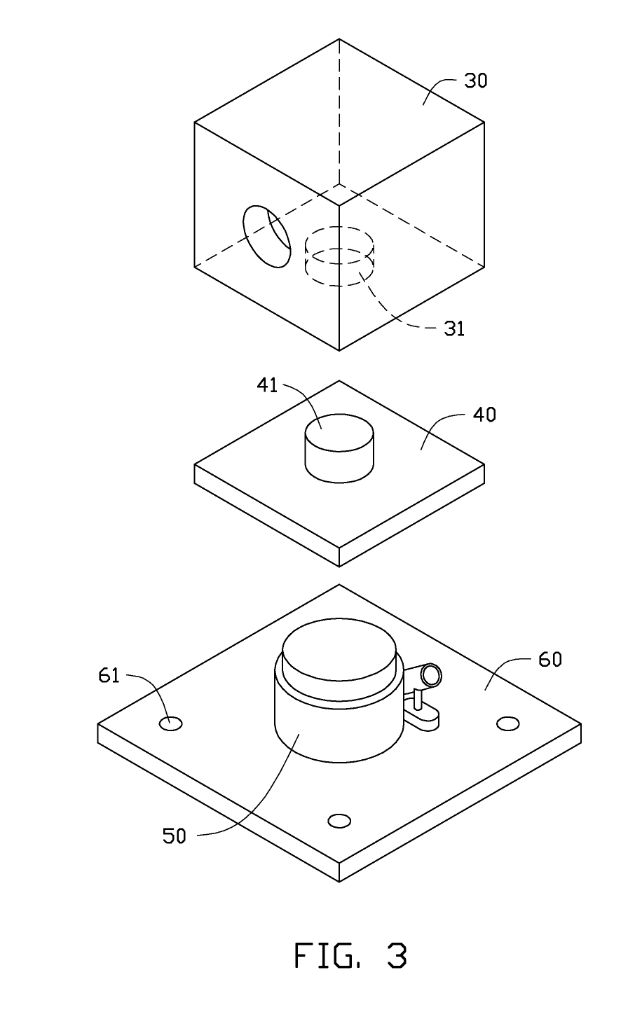

FIG. 3 shows each adjustment member 20 of the container data center. The adjustment member 20 includes a base 60, a jack 50, a connection plate 40, and a supporting block 30. The base 60 defines a plurality of through holes 61. A plurality of anchor nails can fasten the base 60 to a supporting plane (not shown) through the through holes 61. In the embodiment, the jack 50 is a hydraulic jack. A piston rod (not shown) of the jack 50 is connected to a bottom of the connection plate 40. A bottom of the jack 50 is screwed to the base 60. A protrusion 41 protrudes up from the connection plate 40. An engaging hole 31 is defined in a bottom surface of the supporting block 30. The protrusion 41 is engaged in the engaging hole 31.

The supporting blocks 30 are respectively fixed to four corners of the bottom of the container 10 by weld or other manners.

If the supporting plane on which the container data center is placed is uneven, the jacks 50 are operated to move the connection plates 40 up or down for proper distances, to allow the supporting blocks 30 to be located at the same height. The container 10 is ultimately level.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An adjustment member, comprising:
a base;
a jack fixed on the base; and
a supporting block mounted to the jack, and capable of being moved up and down by the jack.

2. The adjustment member of claim 1, further comprising a connection plate connected between the supporting block and the jack.

3. The adjustment member of claim 2, wherein an engaging hole is defined in a bottom surface of the supporting block, a protrusion protrudes from the connection plate and engages in the engaging hole.

4. The adjustment member of claim 1, wherein the jack is a hydraulic jack.

5. A container data center, comprising:
a container; and
a plurality of adjustment members, each adjustment member comprising a base, a jack fixed on the base, and a supporting block fastened between a bottom of the container and the jack, the jack operable of moving the supporting block up and down.

6. The container data center of claim 5, further comprising a connection plate connected between the supporting block and the jack.

7. The container data center of claim 6, wherein an engaging hole is defined in a bottom surface of the supporting block, a protrusion protrudes from the connection plate and engages in the engaging hole.

8. The container data center of claim 5, wherein the jack is a hydraulic jack.
